(19) United States
(12) Patent Application Publication
(10) Pub. No.: US 2026/0230533 A1
(43) Pub. Date: Aug. 6, 2026

(54) METHODS FOR UE/AC/EEC AUTHORIZATION IN GROUP SERVICES PROVIDED BY COMMON EAS DISCOVERY USING AGP WITH AC AUTHORIZATION TYPE AND CREDENTIAL

(71) Applicant: InterDigital Patent Holdings, Inc., Wilmington, DE (US)

(72) Inventors: Zhibi Wang, Woodridge, IL (US); Michel Roy, Candiac (CA); Michael Starsinic, Newtown, PA (US); Taimoor Abbas, Sainte-Julie (CA); Anuj Sethi, Ottawa (CA); Robert Gazda, Spring City, PA (US); Kevin Di Lallo, Laval (CA)

(73) Assignee: InterDigital Patent Holdings, Inc., Wilmington, DE (US)

(21) Appl. No.: 19/151,381

(22) PCT Filed: Feb. 19, 2024
(86) PCT No.: PCT/US2024/016341

§ 371 Date: Jul. 28, 2025

Related U.S. Application Data
(60) Provisional application No. 63/486,767, filed on Feb. 24, 2023.

(51) Int. Cl. H04L 67/51; H04W 12/0433; H04W 12/084

(52) U.S. Cl. CPC H04L 67/51; H04W 12/0433; H04W 12/084

(57) ABSTRACT

A wireless transmit/receive unit (WTRU) may be configured to receive a group profile. The WTRU may send a provisioning request message to an Edge Configuration Server (ECS). The WTRU may further receive an indication of an Edge Enabler Server (EES) associated with the group profile from the ECS in response to the provisioning request message, and send a discovery request message to the EES. The WTRU may receive a discovery response message with information indicating one or more Edge Application Servers (EASs). Moreover, the WTRU may select an EAS based on the discovery response message, and send a provisioning request message to the EES.

### CROSS-REFERENCE TO RELATED APPLICATIONS

This application claims the benefit of U.S. Provisional Patent Application No. 63/486,767 filed on Feb. 24, 2023, the entire contents of which are incorporated herein by reference.

### BACKGROUND

An Application Client (AC) is a user application residing on a user equipment (UE), also known as a wireless transmit/receive unit (WTRU), that may communicate with an Edge Application Server (EAS). A WTRU may use several AC concurrently.

An EAS is an application server resident in an Edge Data Network (EDN). The EAS may be a software server executing on generic hardware located at the edge. The EAS may provide a service to the AC.

There may be multiple EAS instances per EDN. Each EDN may contain a different set of EAS instances of different types (e.g., different EASID). An EAS may serve one or more AC instances that may reside on different WTRUS.

An Edge Enabler Client (EEC) may provide edge support to the AC instances on the WTRU. There may be one or more EEC per WTRU. Each AC may use only one EEC.

An edge enabler server (ees) may provide supporting functions needed by the EAS and/or the EEC.

An Edge Configuration Server (ECS) may provide supporting functions for an EEC or EES to discover EES instances providing certain EAS. There may be one or more ECS for the network.

A Notification Management Client (NMC) may provide supporting functions for an EEC. The supporting functions may allow an EEC to create a notification channel between the NMC and/or the NMS to receive notifications from the ECS and/or EES. Each EEC may use only one NMC.

A Notification Management Server (NMS) may provide supporting functions for an ECS and/or EES. The supporting functions may allow the ECS and/or EES to send notifications to an EEC via a notification channel created between the NMC and the NMS. There may be one or more NMS for the network.

### SUMMARY

The methods in this disclosure focus on authorizing an Application Client (AC) in a group of ACs receiving services provided by a common edge application server (EAS).

A wireless transmit/receive unit (WTRU) may include a processor. The processor may be configured to receive a group profile. The group profile may include an application client (AC) authorization type and AC authorization credentials associated with an AC at the WTRU. The WTRU may send a provisioning request message to an Edge Configuration Server (ECS). The provisioning request message may include information related to the group profile. The WTRU may receive an indication of an Edge Enabler Server (EES) associated with the group profile from the ECS in response to the provisioning request message.

The WTRU may send a discovery request message to the EES. The discovery request message may include the authorization type and AC authorization credentials associated with the AC. The WTRU may receive a discovery response message. The discovery response message may include information indicating one or more Edge Application Servers (EASs). The WTRU may select an EAS based on the discovery response message. The WTRU may send a provisioning request message to the EES. The provisioning request message may include an indication of the selected EAS for the AC.

The provisioning request message in the WTRU may include an indication of the group profile.

The group profile in the WTRU may include an application client group profile (AGP) and an AC group type.

The AGP in the WTRU may include authorization credentials to join a group.

The AC group type in the WTRU may be dynamic grouping, pre-grouping, or none.

The provisioning request message in the WTRU may include the AGP.

The processor in the WTRU may be configured to select the one or more EASs based on the group profile and an application client (AC) group type.

The AC authorization credentials in the WTRU may include an OAuth2 authorization token, generic bootstrapping architecture (GBA) keys, or authentication and key management for applications (AKMA) keys.

The OAuth2 authorization token in the WTRU may include an application client identification (ACID), a scope of the AC, a group ID, a duration of validity, a location of validity, service type, or an EAS list.

The AC authorization type in the WTRU may be an OAuth authorization type, generic bootstrapping architecture (GBA) authorization type, or authentication and key management for applications (AKMA) authorization type.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example of SA6 Architecture for enabling edge applications.

FIG. 3 depicts an example of edge application server (EAS) discovery using an application client (AC) Group Profile.

FIG. 4 depicts an example of EAS discovery using a group server (GS).

FIG. 5 depicts an example of edge enabler server (EES) discovery using a Group Server (GS).

### DETAILED DESCRIPTION

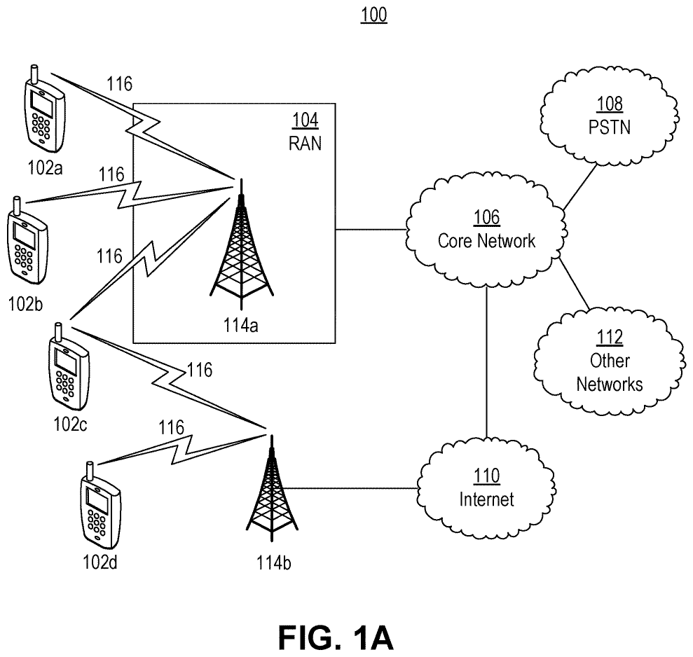

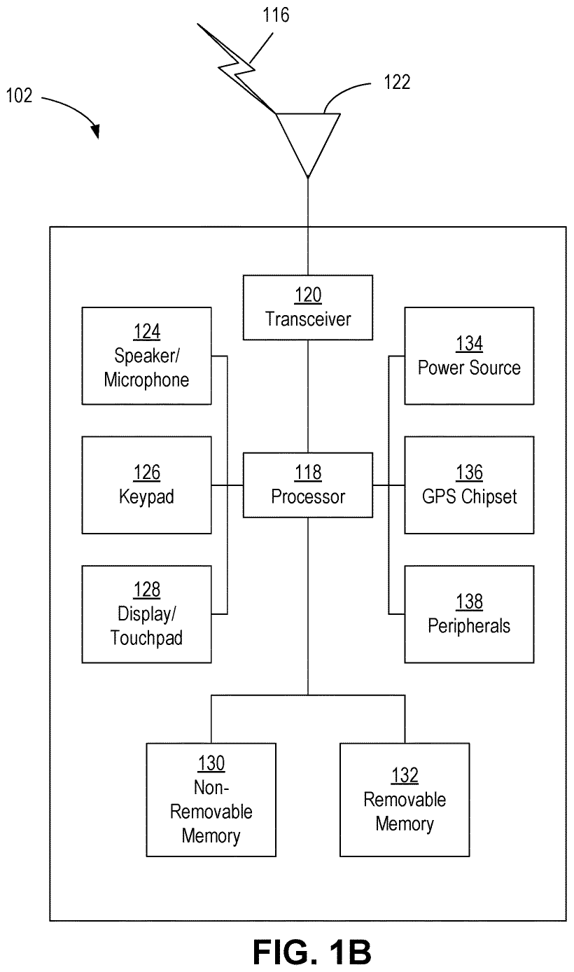

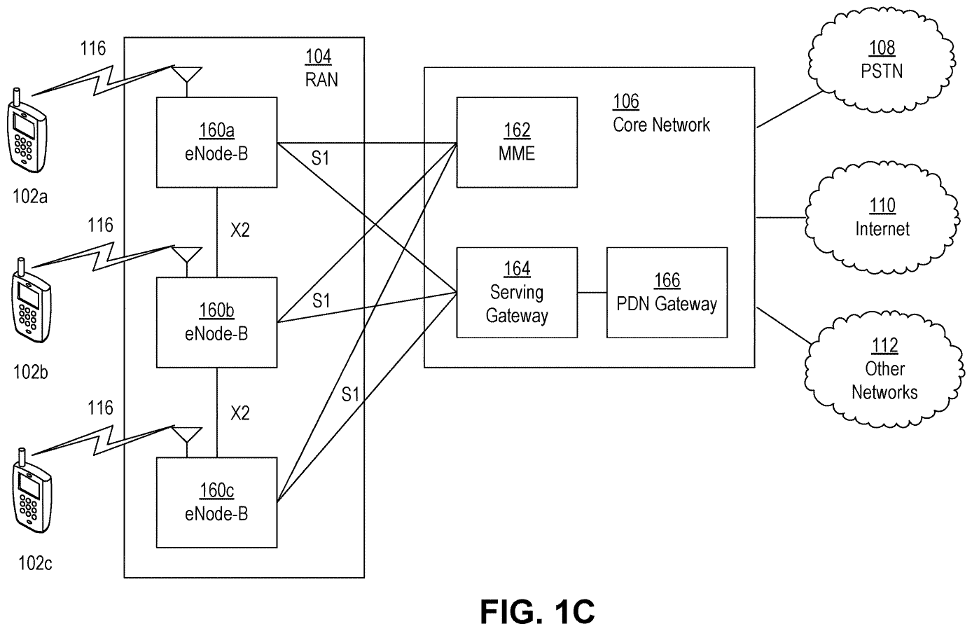

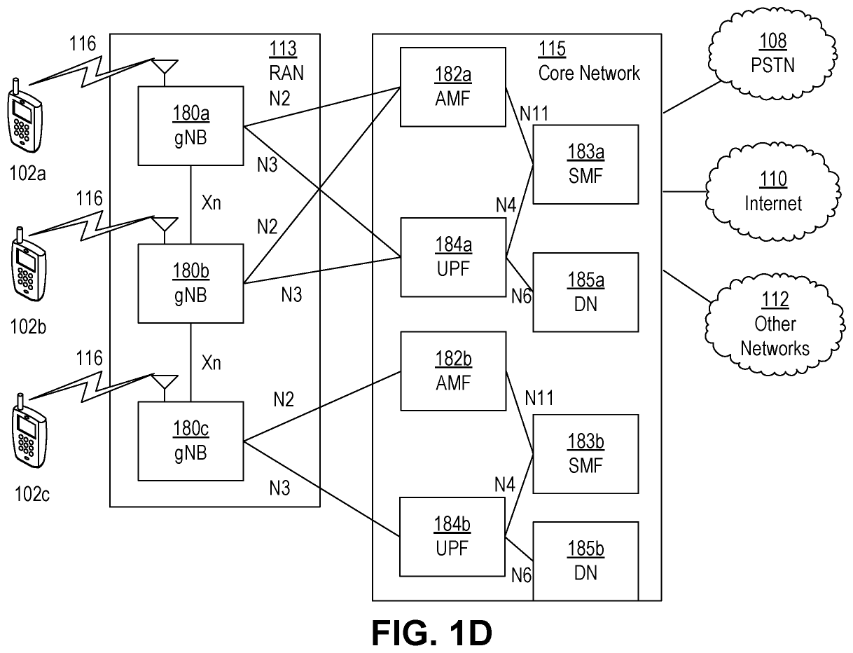

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

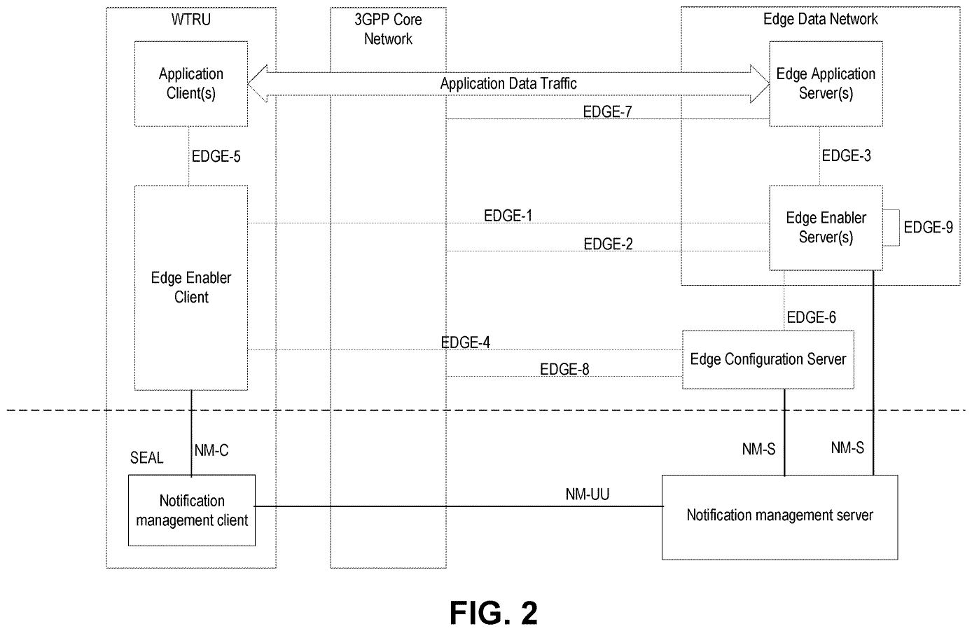

FIG. 2 depicts an example of SA6 architecture and/or application layer for supporting edge services. An Application Client (AC) is a user application residing on a user equipment (UE), also known as a wireless transmit/receive unit (WTRU), that may communicate with an Edge Application Server (EAS). A WTRU may use several AC concurrently.

An EAS is an application server resident in an Edge Data Network (EDN). The EAS may be a software server executing on generic hardware located at the edge. The EAS may provide a service to the AC.

There may be multiple EAS instances per EDN. Each EDN may contain a different set of EAS instances of different types (e.g., different EASID). An EAS may serve one or more AC instances that may reside on different WTRUs.

An Edge Enabler Client (EEC) may provide edge support to the AC instances on the WTRU. There may be one or more EEC per WTRU. Each AC may use only one EEC.

An Edge Enabler Server (EES) may provide supporting functions needed by the EAS and/or the EEC. There may be one or more EES instance per EDN (e.g., and/or per DNN). There may be multiple EDN instances in the network.

An Edge Configuration Server (ECS) may provide supporting functions for an EEC or EES to discover EES instances providing certain EAS. There may be one or more ECS for the network.

A Notification Management Client (NMC) may provide supporting functions for an EEC. The supporting functions may allow an EEC to create a notification channel between the NMC and/or the NMS to receive notifications from the ECS and/or EES. Each EEC may use only one NMC.

A Notification Management Server (NMS) may provide supporting functions for an ECS and/or EES. The supporting functions may allow the ECS and/or EES to send notifications to an EEC via a notification channel created between the NMC and the NMS. There may be one or more NMS for the network.

A user session may be a logical connection between an AC and an EAS. User application data may be exchanged during a user session. To start a user session, an AC may use services from the edge enablement layer (EEL) to establish connectivity with the EDN. Edge services may be deployed on the EDN. The AC may then discover and start exchanging user application data with the selected EAS.

A service provider may deploy several EASs providing the same service in different locations within the EDN. In examples, multiple users (e.g. aCs) may use services from a single common EAS to meet strict latency requirements and/or to avoid the need for inter-EAS synchronization (e.g., gaming with a group of players, a group of robots coordinating together on a manufacturing floor, a team of surgeons using VR headsets and robotic surgery equipment to operate together on a patient, and/or a group of trucks using V2X for platooning).

Use cases may include, e.g., a team of robots coordinating together on a manufacturing floor, a team of surgeons using VR headsets and robotic surgery equipment to operate together on a patient, a group of UAVs flying in a swarm, and/or a group of vehicles using V2X for platooning.

Examples attempt to address how aCs and/or EECs present on different WTRUs may be provisioned with the necessary group security credentials when used for accessing a group service hosted by the same EAS within an EDN.

Moreover, examples also attempt to address how authorization credentials such as the oAuth2 authorization token may be validated before a common EAS services the aCs and/or the EECs.

A Common EAS may refer to an Edge Application Server instance. The Common EAS may reside in a specific EDN. The Common EAS may be discovered and used by several WTRUs (e.g. AC residing on different WTRUs).

A Common EES may refer to an EES where the common EAS is registered. An EAS may register to a single EES.

An AC Group Profile (AGP) may refer to information elements defining a group of aCs. The AGP may contain credentials authorizing to join a group.

An AC group may be composed of multiple aCs and/or EECs in a group service session hosted by a common EAS. In the case of a preformed group, there may be a group leader. The group leader may have the responsibility of managing the group. These responsibilities may include, e.g., membership management, and/or configuration, etc., in addition to an application server.

An AC authorization credential may refer to credentials used to authorize a common EAS to service an AC and/or an EEC for a group service. In examples, a group service may include, e.g., a team of robots coordinating together on a manufacturing floor, a team of surgeons using VR headsets and robotic surgery equipment to operate together on a patient, a group of UAVs flying in a swarm, and/or a group of vehicles using V2X for platooning. In examples, the AC authorization credentials may be an oAuth2 token.

An AC authorization scope may refer to supplementary information that refines the AC credentials behavior. The authorization scope may provide extended characteristics to the credentials. Examples of extended characteristics may include, e.g., the ACID(s) for which the credentials may be applicable to, the time period or duration for which the credentials may be valid, the location/area where the authorization maybe valid, and/or the group identifier for which the credentials may be used.

A Group Server (GS) may refer to a server and/or a central repository for maintaining group information to facilitate sharing the group information across the EEL. A GS may also provide group management services. Group management services may include, e.g., group admission control, group information queries, group session relocation, and/or group notifications.

The examples described herein may be defined in the 3GPP Edge Enablement Layer (EEL). Some solutions may follow the principle that discovery of a common EAS may be performed using the existing EEL architecture and/or using an enhanced EEL architecture that includes a GS. Some solutions may follow the principle that information must be provided to the EEL by the application layer to indicate that a common EAS is used.

Common EAS may enable several application verticals where multiple WTRUs may interact together via a common EAS. The use of a common EAS at the edge may minimize overall latency of communication and/or processing between WTRUs' interactions.

Some proposed solutions may provide the necessary authorization levels in a flexible manner to allow realizing common EAS use cases.

Common EAS discovery may use AGP with AC authorization type and credentials. The AC Group Profile (AGP) may be used in EAS discovery procedure as an additional EAS Discovery Filter to enable aCs/EECs of different WTRUs to discover a common EAS servicing an AC group and provide grouping information with the EEL.

Table 1 presents an example of information elements that may be included in an AC Group Profile:

| Information element | Status | Description |
|---|---|---|
| Group Profile ID | M | Identifier of the group profile |
| AC group type | M | Choice of dynamic grouping (multi-user multi-session, |
| | | etc.), pre-grouped or none (default) |
| List of WTRU filter criteria | O | Information for filtering the WTRUs with associated |
| | | aCs. |
| List of EAS profile | O | List of EAS profile (e.g., as detailed in Table 8.2.4-1). |
| >WTRU group ID | O | If present, it indicates a 3GPP Group ID pre- |
| | | provisioned (e.g., as External Group ID) to the WTRUs |
| | | with aCs in the associated group/association. If group |
| | | leader is coordinating it for the whole group then this |
| | | entry may contain list of group members IDs as well as |
| | | group leader ID. |
| >WTRU service type | O | If present, it indicates a 3GPP service type for the |
| | | Group ID pre-provisioned. |
| >WTRUs service area | O | If provided, it indicates the Service area for |
| | | determining other WTRUs in the association. |
| | | In some examples, the WTRU location may be |
| | | described in clause 7.3.2. The optional additional EAS |
| | | selection criteria describe criteria for the EAS selection |
| | | (e.g., ““same latency for al”” or““lowest latency for the |
| | | own WTRU locatio””). |
| List of associated aCs | O | Information for determining the associated aCs. |
| characteristics | | |
| >common ACID | O | If provided, all aCs in the association have the same |
| | | AC ID as indicated |
| >common aCs Type | O | If provided, all aCs in the association have the same |
| | | AC Type as indicated |
| >common aCs Schedule | O | If provided, all aCs in the association have the same |
| | | AC Schedule as indicated |
| >AC authorization Type | O | If provided, all aCs in the association need to be |
| | | authorized as indicated before joining the group, |
| | | examples of authorization type can be oAuth token, |
| | | GBA/AKMA keys, etc. |
| >AC authorization credentials | O | If provided, the credential is used to authorize AC |
| | | and/or EEC when joining the group |

Different grouping mechanisms may be used to configure a service in common EAS. For example, pre-grouping may be performed out-of-band (e.g., via an external group ID). Each of the association members may be provided with a group profile, which may include an AC Group Profile (AGP) as in Table 1. In examples, AC Group Profiles include, e.g., AC Group type (i.e. pre-grouped), WTRU group ID same for all the ACs, and/or List of Common EAS aggregate Service KPIs. The AC grouping may then be performed at EEL based on AGP information. The AGP may be provisioned by the application layer into AC and/or EEC for a common EAS. In table 1, an AC group type may be a choice of dynamic grouping, pre-grouped or none (default). An AC authorization type may be an OAuth authorization type, generic bootstrapping architecture (GBA) authorization type, or authentication and key management for applications (AKMA) authorization type.

Dynamic grouping may provide characteristics and/or criteria of the individual ACs within the association. The AC grouping may be performed at EEL based on the AGP information.

For both pre-grouping and dynamic grouping, an AC authorization type may be included in the AGP as in Table 1. Table 1 specifies the authorization mechanism that may be used by the AC and/or EEC. Table 1 specifies the AC authorization credentials, which may be included in the AGP, that may be used by the AC and/or EEC when joining a group session with the common EAS. The AC authorization type and AC authorization credentials associated with an AC may be included in the AGP. In examples, the authorization mechanism may indicate an OAuth2 authorization token. The AC authorization credentials may include an OAuth2 authorization token, generic bootstrapping architecture (GBA) keys, or authentication and key management for applications (AKMA) keys. For the pre-grouping case, the authorization may be pre-provisioned and/or pre-configured into the AC and/or the EEC. For the dynamic grouping case, the EEL may populate the authorization credentials into the AC and/or the EEC. In examples, the ECS and/or the EES may be used to generate the group authorization token(s). In examples, the ECS and/or the EES may provide the AC authorization type and/or AC authorization token to the AC and/or EEC for authorizing the AC and/or EEC in the EAS discovery procedure.

For the use case where a first AC and/or EEC may be provisioned, grouping information may include be a group leader, including the AGP and group members. The first AC and/or EEC may discover the common EAS, the AGP, and/or group members. The first AC and/or EEC may provide AC authorization type and credentials to the EES and/or ECS as in the pre-grouping use case. Then, as other AC and/or EEC members join the group, the AC authorization type and credentials may be provided to the AC and/or EEC by the EES and/or ECS. A specially reserved WTRU group identifier may be assigned to the group leader, e.g., 0 or 1, in case a group leader has the responsibility to manage the group.

In examples, depending on the use case, the AS may manage the group information, e.g., membership. The ECS and/or EES may contact the AS to configure the AC and/or EEC that requests to participate the group session. If there is a group leader, the group leader may either manage the group out of channel and/or through connection with the ECS and/or EES.

In examples, the EEC may provide the group AC authorization type, credentials, and group members to the EES during EAS discovery. During the EAS discovery procedure, if the EEC sends an EAS discovery request to an EES including AGP, the EES may determine a common EAS based on the provided AGP. While performing the discovery procedure, the EES may validate the authorization of the AC and/or EEC contained in the AGP sent in the discovery request. If the validation is successful, the discovery procedure for a common EAS may proceed. If the first AC and/or EEC coordinates group creation, then AGP may contain list of group members IDs as well as group leader ID.

In examples, the AC authorization token or OAuth2 authorization token may include the ACID, e.g. scope of the AC and/or EEC such as location of validity, time, duration of validity, group ID, service type, and/or EAS list. User consent may be required to include the AC and/or EEC in the group serviced from a common EAS. If required, the user consent information may be included in the authorization token. The token issuer may digitally sign the authorization token. The entity that receives the request from the token presenter and/or holder may later validate the authorization token.

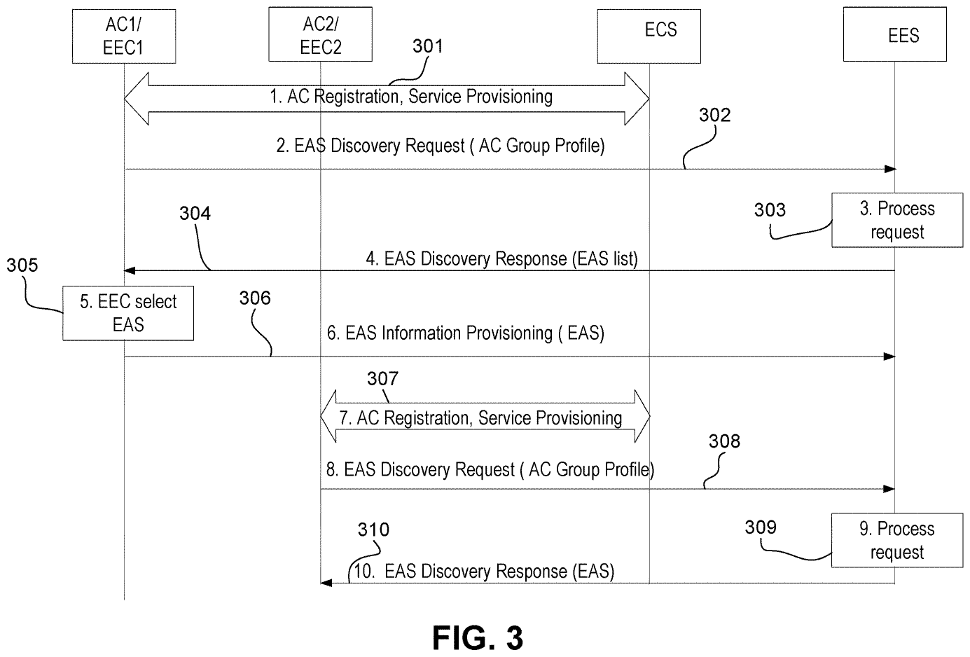

FIG. 3 depicts an example of edge application server (EAS) discovery using an application client (AC) Group Profile. FIG. 3 depicts a sequence diagram for EAS discovery using AGP. FIG. 3 describes the embodiment example with multiple AC joining the group serviced by a common EAS using AC Group Profile.

At 301, the EEC-1 may perform service provisioning with the ECS. The AGP may be provisioned into the EEC as the result of the successful AC registration with the Application Server (AS). For example, the EEC (e.g., the WTRU comprising the EEC1) may receive a group profile from the ECS. The EEC1 may send a provisioning request message to the ECS. For instance, the EEC-1 may include the AGP in the provisioning request message, for example, to attempt to discover the EES and/or EDN where the common EAS is available. The provisioning request message may include an indication of the group profile. The ECS may use the AGP to identify the EES and/or EDN where the common EAS is available.

Additionally or alternatively, the ECS may use the information of the AGP and provisioning request to select an EDN and/or EES for the common EAS. If the AGP contains pre-provisioned AC authorization types and credentials, the ECS may use them to verify if the EEC has authority to discover the EES and/or EDN information for the group.

Additionally or alternatively, if the AGP does not contain pre-provisioned AC authorization types and credentials, the ECS may issue an AC authorization type and/or credentials. The EEC may use the AC authorization type and/or credentials for joining the group at the EES.

At 302, the EEC may send a discovery request message (e.g., an EAS discovery request) to the EES. The EAS discovery request may include an AGP. AGP may include information as in Table 1. This information may include the AC authorization type and AC authorization credentials (e.g., in the discovery request message).

At 303, upon receiving the request, the AC authorization type and/or credentials may be checked, (e.g., OAuth 2 authorization token) is validated to make sure the AC and/or EEC is authorized to discover the common EAS. If the validation is successful, the EES may determine whether a common EAS may be available to provide services to the associated ACs that meet the criteria specified in the AGP. For example, the EES may determine several EASs that meet the AGP criteria. The EES may provide several EASs to the EEC. This may allow the EEC to perform the selection of the common EAS as in 305. For example, the EES may determine and select a single common EAS that meets the AGP criteria. The EES may inform the EEC. When doing so, the EES may use the AGP to create an association between the selected common EAS and the group for future EAS discovery.

At 304, if the processing of the request was successful, the EES may respond to the EEC by sending a discovery response message. For example, the EES may respond with an EAS discovery response message. The EAS discovery response message may include information about the discovered common EAS(s). The EES response may contain a list of EAS that meets the selection criteria if no common EAS is currently associated with the AGP, otherwise the response may contain information about the common EAS selected by the EES.

At 305, the EEC-1 may select one of the discovered EAS to be used as the common EAS if several EASs are provided in the response based on the discovery response message. The EEC-1 may provide the selected common EAS information to AC-1 (not shown on figure).

At 306, the EEC-1 may use the selected EAS information to perform EAS information provisioning by sending a provisioning request message to the EES. EAS provisioning may inform the EES about the selected common EAS by including the selected EAS for the AC in the provisioning request message. EAS provisioning may uniquely identify the selected common EAS within and across EDNs. The EEC may include the AGP in the EAS provisioning request message. The EES may use the selected EAS information and AGP provided by the EEC to associate the selected EAS instance with the AGP. The EEC may select an EAS based on group profile and an application client group type.

Users located on the same or different WTRU may join the session associated with AC-1 and/or EEC-1. For example, at 307, the EEC-2 may perform service provisioning with the ECS. In the service provisioning request, EEC-2 may include, e.g., the EES identifier (EESID) where the common EAS is registered and/or the AGP that contains the EAS selection information. The ECS may use information provided in the service provisioning request to determine the EDN and/or common EES information where the common EAS is registered. The ECS may provide the EDN and/or common EES information associated with the group back to the EEC-2. The ECS may include AC authentication type and/or credentials to be used for accessing the common EAS and/or the common EES. The EEC may need to register to the EES if required by service provisioning prior to executing 308 (not shown on figure).

At 308, if EEC-2 does not know the EAS profile of the common EAS, EEC-2 may perform the EAS discovery procedure with the common EES. Moreover, EEC-2 may include the AGP in the EAS discovery request.

The AGP may include information as in Table 1. The AC authorization type and/or AC authorization credentials may be included. For example, AC-2, via an application programming interface (API), may provide the AGP to the EEC. For example, the AGP may be obtained from one or more of these sources: user configuration via a graphical user interface, via a universal resource identifier, via universal resource location, via pre-configuration on the WTRU, via SMS, via a NAS message, etc.

EEC-2 residing on WTRU-2 may provide AC-2 with AC authentication type and/or AC authentication credentials (e.g., OAuth 2 authorization token).

If the EEC-2 already acquired the common EAS information via other means (e.g., caching the common EAS information from a previous EAS discovery), then the EEC-2 may perform the EAS Information Provisioning procedure with the EES as in 306 (not shown on FIG. 3).

At 309, the EES processes the EAS discovery request from the AC-2 including the EAS selection information and the AGP. The EES may validate the authorization credentials from the AC-2. If the validation is successful, the EES may check for a common EAS already associated to the AGP. In examples, if the AGP used for AC-1 is associated with a common EAS, and AC-2 provides a matching AGP, then the EES may decide to provide the same EAS as decided for AC-1.

The EES may consider if the EEC-2 can use the common EAS by validating the authorization credentials to ensure that EEC-2 is authorized to use the common EAS.

At 310, the EES may respond to EEC-2 with the common EAS used for the group service for the group. The common EAS may be the same EAS previously provided and/or selected by EEC-1.

The EAS discovery response received at the EEC-2 may indicate success or failure. If successful, EEC-2 may inform AC-2 of the common EAS information and AC-2 may access the same common EAS as AC-1.

In examples, ACs may register with an Application Server (AS) first. The AS may configure the ACs with group information to which the AS assigns a globally unique Group identifier. During the registration with the AS, AC may provide their information to the AS to justify the participation of a group service. The information may include the WTRU authentication and/or authorization information. This information may allow the AS to verify the WTRU identity and/or authorize its request to create or join a group. In examples, the WTRU may signup via the AS portal and/or provide its user name and/or charging information.

The AC may obtain AGP information by interacting with the AS to which it is registered. The AS may first verify the AC's information sent in the AC request. The AS may ensure the AC is authorized to participate in the group service provided by a common EAS. The authorization information may vary depending on the group application requested. The information provided by the AS to the AC(s) may include the AC authorization type and/or AC authorization credentials (e.g., a OAuth2 authorization token). The information may be used by the AC(s) and/or EEC(s) during service provisioning and EAS discovery.

Dependent on the use case, the location information of the WTRU may be provided in the format of, e.g., of GPS coordinates, a Cell Identity, and/or a Tracking Area Identity. Furthermore, dependent on the application, during the registration the users may be asked to consent to exchanging the location of their WTRUs with each other. If users' consent is obtained, then the WTRU ACs may for example exchange location information via application level signaling either directly or indirectly via the AS in the cloud.

Based on the WTRU location information received from the ACs, the AS may determine the expected group geographical service area. The AS may provide AGP information along with Group ID as in Table 1. The WTRU service area and/or authorization credentials may be used for group service using a common EAS (e.g., OAuth2 authorization token) digitally signed by the AS. If user consent is exchanged during the registration, the authorization credentials, (e.g., OAuth2 authorization token) may also include the user consent. The authorization credentials, (e.g., OAuth2 authorization token) may be verified through the security chain of trust.

Upon receipt of the Group ID, together with the other parameters such as AC authorization type and/or AC authorization token, each AC may request its respective EEC to perform operations, e.g., service provisioning and/or EAS discovery.

During service provisioning, the ECS may receive the geographical service area. The ECS may use the geographical service area to determine a common EES by comparing the geographical service area with the EES geographical service area received from each EES during EES registration.

During EAS discovery, the EEC-1 present on WTRU-1 may provide the common EES with WTRU-1 location, the locations of the other WTRUs participating in the group, and/or the AC authorization token to use service from the common EAS. Based on the location information of all WTRUs involved in the session and other information included in the EAS discovery request, e.g., as Group ID and/or AC authorization token, the EES may determine a common EAS and indicates it to the EEC-1.

The EES may initiate determination of a common EAS for the WTRUs based on different information present in the EAS discovery request and/or application information, e.g., using the AGP that contains WTRU service area and service type, if available, and/or using information that proves that a common EAS may serve the EEC.

The information may be an AC authorization type and/or AC authorization credentials (e.g., OAuth2 authorization token). The AC authorization credentials (e.g., OAuth2 authorization token) may contain the scope of the AC that a common EAS has authorized to service.

An AC authorization scope may refer to supplementary information that refine the AC credentials behavior. The authorization scope may provide extended characteristics to the credentials, e.g., the ACID(s) for which the credentials may apply, the time period and/or duration for which the credentials may be valid, the location and/or area where the authorization may be valid, and/or the group identifier for which the credentials may be used, etc.

If a late-coming AC joins the group after the initial EAS discovery was initiated, the AC may register with the AS to obtain AGP information. The AC, through the EEC. may then register with the EES and perform EAS discovery, providing the AGP received from the AS. The EES may determine the common EAS based on the AGP and the AC authorization credentials (e.g., OAuth2 authorization token) for AC to be authorized to use the group service provided by the common EAS.

In examples, a common EAS may perform discovery based on a Group Server. The Group Server (GS) may maintain the EAS allocation information that services groups of WTRUs. The group may be formed before EEC triggers EAS discovery. A pre-configured or dynamic group may select a common EAS that services the group.

An AS may provide the information about the common EAS if the AS has already been pre-selected, and this information may be used by the GS.

The AGP may include the AC authorization type and/or AC authorization credentials (e.g., OAuth2 authorization token) as in Table 1. The GS may validate the AC authorization credentials (e.g., OAuth2 authorization token) to make sure the AC and/or EEC are authorized to join the group and/or share the service from the common EAS before allocating a common EAS.

The group information (e.g. group ID) in the AGP or group profile may be used as part of the allocation information to anchor WTRUs to the common EAS. The GS may maintain the allocation information. When an EES is aware of the selected common EAS when receiving a request from an EEC (e.g., receiving an EAS discovery request and/or EAS information provisioning request), the EES may contact the GS. The GS may decide whether to allow the EES to proceed with the currently selected common EAS by verifying that the AC and/or EEC is authorized to join a group and/or access the selected common EAS.

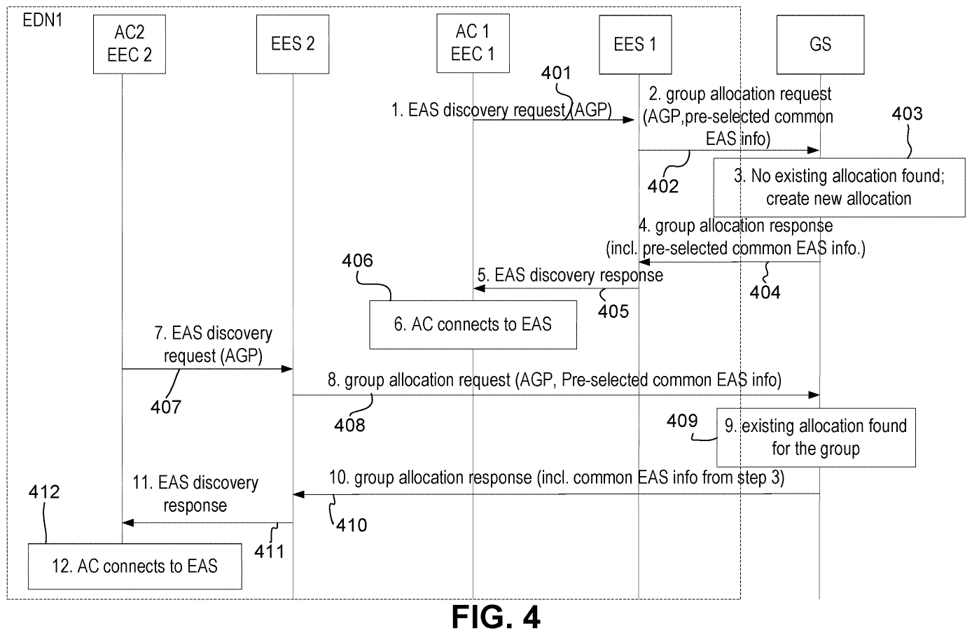

The EDN ID may be used to identify an EDN and may be part of the allocation information. FIG. 4 depicts an example of EAS discovery using a group server (GS). FIG. 4 shows the detailed procedure of using a GS for common EAS discovery. In this procedure, EDN and/or EES information may be available at the EEC. The EDN and/or EES information may be obtained by the EEC or the WTRU for example via pre-configuration, user provided configuration, and/or a service provisioning procedure.

Though not shown in FIG. 4, an AGP is provisioned to each WTRU. At 401, an EEC 1 may send an EAS discovery request to EES 1 which may include, for example, an indication of an application client at the EEC, one or more of an EAS ID, a WTRU ID, an AC identifier, an indication of a AGP associated with the AC, AC authorization credentials (e.g., OAuth2 authorization token).

At 402, the EES 1 may pre-select a common EAS. The EES 1 may send a group allocation request message to the GS. The request message may contain AGP along with information associated with the application client group profile (AGP), such as the AC authorization token received from EEC 1. The request message may include pre-selected common EAS information and associated information. The AGP may include an AC authorization token and an AC authorization scope. The AC authorization token may include the authorization scope for the common EAS allocation. The AC authorization credential may include an authorization scope.

At 403, the GS may validate the AC authorization token and scope. If the validation is successful and no existing allocation information is found, the GS may create a new allocation information associated with the AGP with the EAS for the WTRU group after the AC authorization token and scope are successfully validated. The GS may form an association between the group information provided in the AGP and/or the common EAS information.

At 404, the GS may respond to the group allocation request with a successful result by providing a group allocation response message to EES 1 the newly created allocation information. The group allocation response message may include the pre-selected common EAS provided in the request of 402 as the common EAS to use for that group.

At 405 and 406, the EES 1 may respond to EEC 1 with a successful EAS discovery response. The EAS discovery response may include the common EAS information for the AC. The EAS discovery response may indicate that the AC is authorized to participate to the group session with the EAS or the common EAS. EEC 1may consequently provide the selected common EAS information or information associated with the EAS to AC1 for communication with the EAS. The AC1 may connect and/or communicate with the selected common EAS.

At 407, EEC 2 may send an EAS discovery request to EES 2 which may include the selected EAS information. The selected EAS information in the discovery request message may include, for example, one or more of an EAS identifier (ID), a WTRU identifier (ID), an AC ID, and/or an AGP along with AC authorization credentials (e.g., OAuth2 authorization token). The AC authorization credentials may include an authorization scope or an OAuth2 token.

At 408, EES 2 may pre-select a common EAS. The common EAS may be different from the one provided to EEC 1. The common EAS may send a group allocation request message to the GS. The request message may contain AGP along with information associated with the application client group profile (AGP), such as the AC authorization token received from the EEC. The request message may include pre-selected common EAS information and associated information. The AGP may include an AC authorization token and an AC authorization scope. The AC authorization token may include the authorization scope for the common EAS allocation.

At 409, the GS may validate the AC authorization token and scope. If the validation is successful and there is pre-existing allocation information for the WTRU group, the GS may select the pre-existing allocation information associated with the AGP with the EAS.

At 410, the GS may respond to group allocation request with a successful result by providing a group allocation response message to the EES 2 the pre-existing allocation information. The pre-existing allocation information may include the common EAS information previously determined. Upon receiving the response, EES 2 may not proceed with the pre-selected common EAS. EES 2 may use the common EAS information included in the response instead.

At 411 and 412, the EES-2 may respond to EEC 2 with a successful EAS discovery response, including the common EAS information associated with the group on 403 and provided to EEC 1 in 405. The successful EAS discovery response may indicate that the AC is authorized to participate the group session with the common EAS. Though not shown on the figure, if the response contains common EES information, EEC 2 may perform a service provisioning procedure to obtain service provisioning information about EES 1. EEC 2 may establish connectivity with EES 1. Though not shown on the figure, if the response did not include common EAS information, upon establishing connectivity with EES 1, EEC 2 may perform 407 to 411 again with EES 1 as to obtain common EAS information. Upon obtaining common EAS information, EEC 2 may consequently inform AC2 which may connect and communicate with the common EAS.

In examples, a common EES may be provisioned using a GS. The GS may maintain the EAS allocation information that services groups of WTRUs. The group may be formed before EEC triggers Service Provisioning. A pre-configured or dynamic group may select a common EES that services the group.

An AS may provide the information about the common EES if the AS has already been pre-selected. The GS may use this information. The AGP may include the AC authorization type and AC authorization credentials (e.g., OAuth2 authorization token) as in Table 1. The GS may validate the AC authorization token to ensure the AC and/or EEC are authorized to join the group and/or be provisioned with the common EES.

The group information (e.g. group ID) in the AGP may be used as part of the allocation information to anchor WTRUs to the common EES. The allocation information may be maintained on a GS. When an ECS is aware of the selected common EES when receiving request from a EEC, (e.g., receiving a service provisioning request), the ECS may contact the GS. The GS may decide whether to allow the ECS to proceed with the common EES by verifying that the EEC is authorized to join a group or access the common EES.

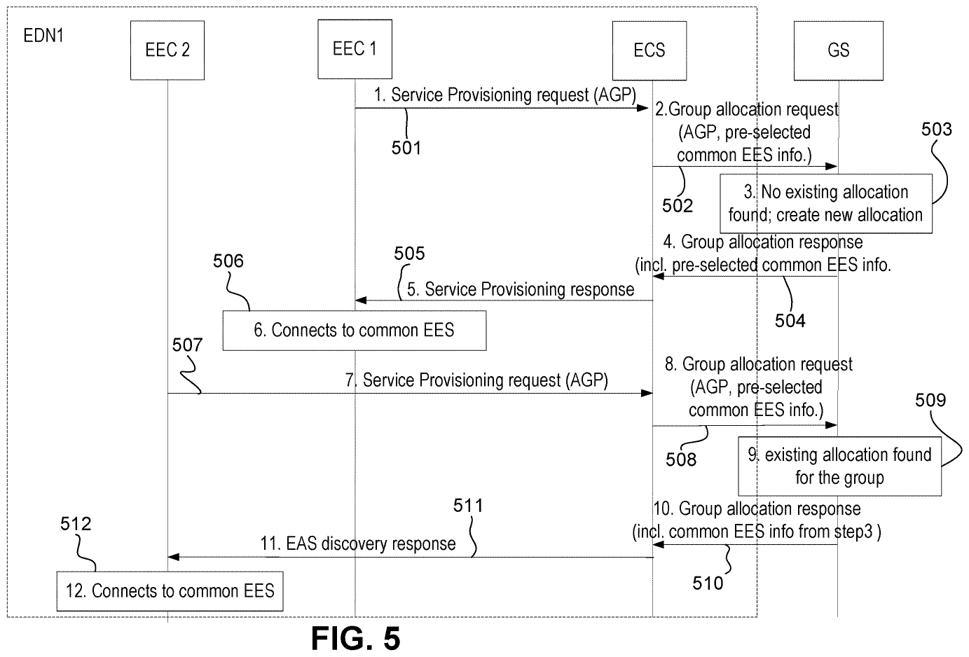

FIG. 5 depicts an example of edge enabler server (EES) discovery using a Group Server (GS). As depicted in FIG. 5, at 501, the EEC 1 may send a service provisioning request to the ECS which may include the AGP and/or AC authorization credentials such as an OAuth2 token.

At 502, an ECS may pre-select a common EES. An ECS may send a group allocation request message to the GS. The request message may contain AGP along with the AC authorization token received from EEC 1. The request message may include pre-selected common EES information. The AC authorization token may include the authorization scope for the common EES allocation.

At 503, the GS may validate the AC authorization token and scope. If the validation is successful and there is no existing allocation information found, the GS may create a new allocation information for the WTRU group. The GS may form an association between the group information provided in the AGP and the common EES information.

At 504, the GS may respond to the group allocation request with a successful result by providing to the ECS the newly created allocation information. This allocation information may include the pre-selected common EES provided in the request of 502 as the common EES to use for that group.

At 505 and 506, the ECS may respond to EEC 1 with a successful service provisioning response. The response may include the common EES and/or EDN information. The response may indicate that the AC is authorized to join the group. The EEC 1 may consequently establish connectivity and communicate with the common EES. Though not shown in FIG. 5, the EEC 1 may proceed to discover the common EAS.

Additionally or alternatively, AC1 may send common EES information as received from GS to all other ACs in a group via direct communication. This communication may be assumed if there is any direct link between the WTRU.

At 507, the EEC 2 may send a service provisioning request to ECS which may include the AGP along with AC authorization credentials (e.g., OAuth2 authorization token).

At 508, the ECS may pre-select a common EES. The common EES may be different from the common EES provided to EEC 1. The common EES may send a group allocation request message to the GS. The request message may contain AGP along with the AC authorization token received from the EEC and/or may include pre-selected common EES information. The AC authorization token may include the authorization scope for the common EES allocation.

At 509, the GS may validate the AC authorization token and scope. If the validation is successful and there is pre-existing allocation information for the WTRU group, the GS may select the pre-existing allocation information.

At 510, the GS may respond to the group allocation request with a successful result by providing to the ECS the pre-existing allocation information. The pre-existing allocation information may include the common EES information previously determined in 503. Upon receiving the response, the ECS may not proceed with the pre-select common EES. Rather, the ECS may use the common EES information included in the response instead.

At 511 and 512, the ECS may respond to EEC 2 with a successful service provisioning response, including the same common EES and EDN information as provided to EEC1 in 505. This provisioning response may indicate that the AC is authorized to join the group. Though not shown in FIG. 5, the EEC 2 may consequently establish connectivity and/or communicate with the common EES and proceed in discovering the common EAS.

What is claimed is:

1. A wireless transmit/receive unit (WTRU) comprising:
a processor configured to:
receive a group profile associated with an application client (AC) at the WTRU;
send a provisioning request message to an edge configuration server (ECS), wherein the provisioning request message comprises information related to the group profile;
receive an indication of an edge enabler server (EES) associated with the group profile from the ECS in response to the provisioning request message;
send a discovery request message to the EES;
receive a discovery response message, wherein the discovery response message comprises information indicating one or more edge application servers (EASs);
select an EAS based on the discovery response message; and
send a provisioning request message to the EES, wherein the provisioning request message comprises an indication of the selected EAS for the AC.

2. The WTRU of claim 1, wherein the provisioning request message comprises an indication of the group profile, wherein the group profile comprises an AC client authorization type and AC authorization credentials associated with the AC, and wherein the discovery request message comprises the AC authorization type and the AC authorization credentials.

3. The WTRU of claim 2, wherein the group profile comprises an application client group profile (AGP) and an AC group type.

4. The WTRU of claim 3, wherein the AGP comprises authorization credentials to join a group.

5. The WTRU of claim 3, wherein the AC group type is dynamic grouping, pre-grouping, or none.

6. The WTRU of claim 3, wherein the provisioning request message comprises the AGP.

7. The WTRU of claim 1, wherein the processor is configured to select the one or more EASs based on the group profile and an application client (AC) group type.

8. The WTRU of claim 2, wherein the AC authorization credentials comprise an OAuth2 authorization token, generic bootstrapping architecture (GBA) keys, or authentication and key management for applications (AKMA) keys.

9. The WTRU of claim 8, wherein the OAuth2 authorization token comprises an application client identification (ACID), a scope of the AC, a group ID, a duration of validity, a location of validity, a service type, or an EAS list.

10. The WTRU of claim 2, wherein the AC authorization type is an OAuth authorization type, a generic bootstrapping architecture (GBA) authorization type, or an authentication and key management for applications (AKMA) authorization type.

11. A method implemented by a wireless transmit/receive unit (WTRU), the method comprising:
receiving a group profile associated with an application client (AC) at the WTRU;
sending a provisioning request message to an edge configuration server (ECS), wherein the provisioning request message comprises information related to the group profile;
receiving an indication of an edge enabler server (EES) associated with the group profile from the ECS in response to the provisioning request message;
sending a discovery request message to the EES;
receiving a discovery response message, wherein the discovery response message comprises information indicating one or more edge application servers (EASs);
selecting an EAS based on the discovery response message; and
sending a provisioning request message to the EES, wherein the provisioning request message comprises an indication of the selected EAS for the AC.

12. The method of claim 11, wherein the provisioning request message comprises an indication of the group profile, wherein the group profile comprises an AC client authorization type and AC authorization credentials associated with the AC, and wherein the discovery request message comprises the AC authorization type and the AC authorization credentials.

13. The method of claim 12, wherein the group profile comprises an application client group profile (AGP) and an AC group type.

14. The method of claim 13, wherein the AGP comprises authorization credentials to join a group.

15. The method of claim 13, wherein the AC group type is dynamic grouping, pre-grouping, or none.

16. The method of claim 13, wherein the provisioning request message comprises the AGP.

17. The method of claim 11, wherein the processor is configured to select the one or more EASs based on the group profile and an application client (AC) group type.

18. The method of claim 12, wherein the AC authorization credentials comprise an OAuth2 authorization token, generic bootstrapping architecture (GBA) keys, or authentication and key management for applications (AKMA) keys.

19. The method of claim 18, wherein the OAuth2 authorization token comprises an application client identification (ACID), a scope of the AC, a group ID, a duration of validity, a location of validity, a service type, or an EAS list.

20. The method of claim 2, wherein the AC authorization type is an OAuth authorization type, a generic bootstrapping architecture (GBA) authorization type, or an authentication and key management for applications (AKMA) authorization type.
